(19) United States
(12) Patent Application Publication
(10) Pub. No.: US 2024/0315305 A1
(43) Pub. Date: Sep. 26, 2024

(54) APPARATUS AND METHOD FOR PRODUCING MATERIALS

(71) Applicants: YISSUM RESEARCH DEVELOPMENT COMPANY OF THE HEBREW UNIVERSITY OF JERUSALEM LTD., Jerusalem (IL); SAVOREAT LTD., Rehovot (IL)

(72) Inventors: Ido BRASLAVSKY, Nes Ziona (IL); Oded SHOSEYOV, Shoham (IL); Shay SHEMESH, Rehovot (IL); Moshe AKNIN, Modiin-Maccabim-Reut (IL); Yogev NAIIM, Tel Aviv (IL); Doron COHEN, Natanya (IL); Omer GENKIN, Tel-Aviv (IL)

(21) Appl. No.: 18/259,825

(22) PCT Filed: Dec. 29, 2021
(86) PCT No.: PCT/IL2021/051547

§ 371 Date: Jun. 29, 2023

Related U.S. Application Data
(60) Provisional application No. 63/199,439, filed on Dec. 29, 2020.

(51) Int. Cl. A23P 20/20; A23P 20/25; B33Y 10/00; B33Y 30/00; B33Y 40/10

(52) U.S. Cl. CPC A23P 20/20; A23P 2020/253; B33Y 10/00; B33Y 30/00; B33Y 40/10

(57) ABSTRACT

The invention generally relates to a digital manufacturing system unit for manufacturing a food product, the system unit being a non-partitioned system unit comprising a raw material metering and mixing unit, a food product assembly unit and a food product cooking unit, the system unit being configured and operable to receive one or more customer-specified requirement relating to a food product profile and execute a set of machine instructions specifying a manufacturing process suitable for manufacturing the food product based on the food product profile, thereby manufacturing the food product. The invention also relates to a method for digital manufacturing a food product using such a system.

### FIELD OF THE INVENTION

The present invention generally relates to an apparatus for producing substances and methods for producing same. In particular, the invention relates to production of food products.

### BACKGROUND OF THE INVENTION

Modern life, technology advancement, and easily accessible information over the internet have created a desire amongst consumers for specialized and/or personalized products. Yet not all products available meet the desires and requirements of the average consumer. Accordingly, often consumers compromise and purchase products which are mostly suitable, but which tend not to meet their specific needs or desires.

Generally, food is produced in mass production, and specialized/personalized products are provided by manufactures that wish to expand their market share and spread out to further potential consumers (e.g., health conscience consumers, children). Such products are mostly deficient in meeting a consumer's needs specifically since consumer awareness of food compositions and quality extending to product specifications would require manufacturers of food products to produce an unimaginable number of different products. A health conscience person seeking a specific product having a specific composition may not compromise in a consumed food on inclusion of low-fat foods rather to high fat foods, and natural ingredients rather than synthetic ingredients, even if substantially similar products are offered for sale; a child longing for a square and thin pizza will not compromise with a different type of food, even if a round pizza may be offered; and a gourmet consumer may not taste a favorite food which is served at a temperature other than expected. It is therefore practically impossible for food manufacturers to satisfy all consumer desires and requirements.

The need thus exists to provide a cooking apparatus that can be operated to provide a specific product meeting a consumer's specific desires.

US 2018/0007949 discloses a cooking apparatus capable of using three-dimensional (3D) printing technology to form food products. The cooking apparatus includes a main body, wherein a cooking compartment is provided in the main body, and a cartridge assembly is installed in the cooking compartment to be capable of linear motion and rotational motion. The cartridge assembly includes a cartridge body having cartridge mounts, cartridge cases mounted on the cartridge mounts, and cartridges are disposed in the cartridge cases and include food ingredients that are accommodated therein.

### PUBLICATIONS

[1] US 2018/0007949

### SUMMARY OF THE INVENTION

In an attempt to provide means for production of specialized or personalized food products, which characteristics (composition, size, shape etc) can be tailored for consumers' desires, the inventors of the technology disclosed herein have developed a system or an apparatus or a 3D printing unit for manufacturing food products of a variety of compositions, textures, shapes and sizes, whereby the consumer specifically and selectively determines the product composition and other product attributes. Unlike 3D printers of the art, manufacturing systems of the invention combine in a single unpartitioned system unit product manufacturing and product cooking units configured and operable to meeting a consumer's desires.

Systems of the invention provide a consumer/end user with the ability to choose the food product of their desire by specifically selecting ingredients and their amounts, the product shape, size and other parameters per user's desires. In other words, an end user can utilize a system of the invention to produce a meat product, a dairy product, a vegan product, a low-calorie product, an allergen-free product, a gluten free product, a kosher product and a great variety of other products, by specifically selecting the food ingredients from which the food products will comprise, the flavors that will be used, the size of the product (weight or dimensions), the degree of cooking (well done, medium well, medium or raw-in case of meat products—or juicy, crispy or other-in case or non-meat products) etc.

In developing a system of the invention, the inventors have extended the system to manufacturing a gamut of industrially applicable 3D products or objects, e.g., made of polymeric materials, ceramic materials as well as other materials commonly used in additive manufacturing or 3D printing.

Thus, in its most general aspect the invention provides a digital manufacturing unit or a “system unit” comprising a raw material metering and mixing unit, a product assembly unit and a product fixing or priming unit, the system unit being configured and operable to receive one or more customer-specified requirements relating to a food product profile (composition, size, shape, etc) and execute a set of machine instructions specifying a manufacturing process suitable for manufacturing the food product based on the food product profile, causing manufacturing of the food product.

The “food product profile” defines the customer-specific attributes of the product. Such attributes may be relating to the composition of the product defining the nature of the product as a dairy product, an allergen free product, a vegan product, a vegetarian product, a low-salt product, a product suitable for diabetics, a kosher product, etc; the size of the product, namely its weight, volume, thickness or size in centimeters; the shape of the product and other attributes such as color, fragrance, etc. The customer-specific requirements defining the food product profile may relate to generally any of the above attributes or to specific attributes such as product sweetness, saltness, oiliness, dryness, cooking level and others.

In some implementations of a system unit according to the invention, the system unit comprises a raw material processing unit which includes the raw material metering and mixing unit (namely—it includes one or more material metering, mixing, heating, pressuring, extruding, grinding, etc). Thus, in such configurations, the system unit may comprise a raw material processing unit (including the raw material metering and mixing unit), a product assembly unit and a product fixing or priming unit. In other words, where a raw material processing unit exists, a system unit is provided which comprises a raw material unit, a product assembly unit and a product priming unit; wherein the raw material unit comprises a plurality of stationary raw material canisters (or reservoirs or containers), each being in material communication with one or more mixing containers configured and operable to receive one or more raw materials from the canisters or from previous processing steps or containers inside the unit, formulate same into one or more raw material combinations and deliver the one or more combinations into a printing head assembly.

The invention further contemplates a “unit series” which comprises two or more or a plurality of system units, as defined herein. The unit series is configured and operable for producing one or more products simultaneously or in parallel. Each system unit comprises a raw material processing unit, as defined, a product assembly unit and a product cooking (solidifying, curing or roasting) unit, whereas a unit series may comprise a plurality of system units, each defined as herein, or two or more system units sharing a single or common raw material unit and separate product assembly units and product priming units.

The invention further provides a system unit being a digital manufacturing or printing unit comprising a raw material unit (which may be contained in a refrigerated zone or chamber), a product assembly unit and a product priming unit; wherein the raw material unit comprises a plurality of stationary raw material canisters (or reservoirs or containers, each optionally refrigerated or maintained at a temperature below room temperature, namely below 25-30° C.; or maintained at a temperature between 0 and 20° C.), each being in material communication with one or more mixing containers configured and operable to receive a raw material and optionally form a raw material combination.

As the raw material unit may be kept at a temperature below room temperature, and as the product priming unit (cooking unit) is heated to permit cooking of the food products, the two units are typically maintained at two ends of the system unit. However, they are not separated by any physical thermally insulating separator or partition. In fact, the unit of the invention does not comprise or include any unit separator or a partition which separates the hot unit (the cooking unit) from the cold unit (the refrigerated zone).

A system unit of the invention is a closed system unit enabling raw material delivery, product formation and priming-all in a single system unit, containing no zone separators. In other words, all processes are carried out and completed within the same single unit and do not require further pre-processing or post-processing steps at a station or unit outside of the system unit of the invention.

The raw materials are typically contained in a plurality of stationary canisters or cartridges that are attached to any stationary unmovable part of the system unit, e.g., the internal walls or any structure present within the unit or frame of the unit. The canisters may be of a shape and size or a material adapted to receive specific raw material ingredients, differing one from the other in composition; form, e.g., some may be liquids, other may be solids/powders or solutions; viscosity; lability or specific sensitivity, e.g., to oxidation, hydrolysis or heat; the specific storage conditions, e.g., maintained under inert conditions, or at a particular temperature, etc; and others. Each canister may be selected or configured to meet the demands of the particular raw material contained therein. The canisters may be configured to receive a raw material from an external reservoir or an external source, or are pre-filled disposable canisters, in which case the raw material unit is provided with a plurality of adaptors that are configured to associate to the disposable container or cassette, and after use dissociate therefrom. The adaptors may be provided in different forms, such as in a form of a puncturing needle, a puncturing knife, a threaded bolt or nut, an alignment post or alignment hole, a mounting boss or mounting recess, or a sheet metal tab or slot connector. The adaptors may be provided in or equipped with a holding frame or element that securely holds the container in place.

The number of canisters may vary from one system unit to another. Typically, the number of canisters in a unit of the invention is equal to the number of components or mixtures thereof that are provided for manufacturing the product, e.g., food product. For example, a plurality of canisters may be provided such that one contains a protein, another contains a fiber material and others may include flavoring agents, coloring agents, and other food ingredients. The number of canisters is always at least at least 1.

In some embodiments, the number of canisters is at least 1, or 2 or 3 or more. In some embodiments, the number of canisters is 3, 4 or 5.

The canisters may be oriented at any angle to a printing or deposition surface, as defined herein. The canisters may be oriented horizontally or vertically or at an angle to the printing or deposition surface or tray or may be provided with a tilting mechanism (mechanical or electric) to enable complete decanting of the canisters content. In some embodiments, each of or a plurality of canisters is provided with a tilting mechanism which enables mechanical or electric tilting. Irrespective of their ability to tilt with respect to the printing or deposition surface, or irrespective of their orientation, the canisters are fixed within the unit (their position within the unit does not and cannot be changed).

In some embodiments, the canisters or cartridges are positioned parallel to the deposition tray. In other embodiments, the canisters or cartridges are positioned perpendicular to the deposition try.

The canisters may be further equipped or associated to a decanting mechanism or any means to withdraw a metered amount of a raw material from one or more of the canisters. The decanting mechanism may be operable to permit uninterrupted flow of raw materials from the canisters or may utilize a positive displacement device such as a pump to withdraw a metered amount. In some embodiments, each of the canisters or cartridges is provided with an output opening or valve from which material may be dispensed. In some embodiments, material dispensing through the output opening is governed or controlled by the decanting mechanism that is associated with each of the canisters or cartridges and which causes dispensing of a material from each of the canisters or cartridges.

For some applications or when using certain raw materials, the canisters may be heated or maintained at a low temperature, as detailed herein, to permit a better material flow, stabilize the raw material or prevent it from decomposing, decaying or disintegrating.

The metered amounts of the raw materials may be transferred from the raw material canisters into the printing head for forming the 3D object. In some implementations, the printhead may be provided with a mixing container in which a material combination is formed and subsequently emptied or delivered to the printhead for printing.

Each of the canisters or cartridges may be replaced with a new one or may be configured for repetitive refiling and use.

The printhead or deposition tool is part of a product assembly unit, which is configured to discharge any one or more raw materials or a combination of raw materials via one or more nozzles. The nozzles are provided with an end receiving the raw materials or combination thereof from said mixing containers or canisters and an outlet end through which the raw material or combinations thereof is discharged. The outlet end is provided with a planar extension that extends an outer circumference of the nozzle outlet. The planar extension is provided for maintaining an object thickness defined by the distance between the printing surface and the planar extension. In some embodiments, the planar extension is a heated body which permits thermally priming, e.g., solidifying, curing or cooking of the formed object.

In some embodiments, the printhead or deposition tool makes part of a canister or a cartridge containing the raw material(s). In other words, a separate print head or deposition tool may not be present. In such a configuration, material deposition occurs directly from the one or more canisters onto the deposition surface, e.g., tray.

The printhead assembly is configured for linear motion or a rotational motion onto a printing or deposition surface or a tray, which may be heated. In some embodiments, however, the printhead or deposition tool may be fixed in position, namely stationary, and the print or deposition surface or tray may be configured to move with respect to the position of the printhead or deposition tool.

In some embodiments, both the printhead/deposition tool and the deposition surface or tray have the freedom to move in all directions relative to each other.

The invention further provides a system for manufacturing an object such as a food product, the system comprising one or more canisters or cartridges, each being stationary and configured to hold a solid, a liquid or a semi-solid raw material and discharge a metered amount of the raw material via one or more nozzles;
wherein the system further comprises a product priming unit, e.g., a food cooking or heating unit.

In some embodiments, the system further comprises one or more mixing containers, each being configured and operable to receive a raw material from the one or more canisters or cartridges and discharge a combined raw material via one or more nozzles.

In such configurations, the system may comprise
one or more canisters, each being stationary and configured to hold a solid, a liquid or a semi-solid raw material
one or more mixing containers, each configured and operable to receive a raw material from the one or more canisters and discharge a combined raw material via one or more nozzles;
wherein the system further comprises a product priming unit, e.g., a food product cooking unit.

In some embodiments, the system may further comprise a product extraction unit.

The product priming unit receives product manufactured in the manufacturing unit and treats the product to endow it with final desired characteristics. The priming unit comprises any one or more curing elements such as heating lamps, heating bodies, UV lamps, IR lamps, lasers (UV, VIS, or IR), hot air nozzles, heating trays or surfaces and others.

In some embodiments, the priming unit comprises a substrate with a multiplicity of heating elements arranged in an array form. In some embodiments, the array comprises multiple individually addressable heating elements, each of the elements may be the same or different. Each of the elements may be addressed at the same time or at different time points.

In some embodiments, the priming unit comprises a heating assembly comprising two heating surfaces: a top heating surface and bottom heating surface, wherein the product, e.g., food product, is positioned on the bottom heating surface. The position of either the top surface or the bottom surface may be modified such that the product to be primed or cooked is in contact with the bottom heating surface or with both surfaces, e.g., sandwiched therebetween, to achieve thermal priming or cooking from the bottom surface or from the bottom and top surfaces. In some embodiments, the heating surfaces are in contact with the product that is sandwiched therebetween. In other embodiments, the product is positioned on the bottom heating surface and the top surface is at a non-contacting distance from the product. In some embodiments, each of the heating surfaces is coated with a non-stick surface that can be replaced between any two cooking sessions, as further detailed herein.

In some embodiments, the deposition tray receives the product to be primed or cooked and delivers it to the heating assembly.

In a system of the invention which comprises a product manufacturing unit, e.g., a printhead (deposition tool), and a product priming assembly, the product priming assembly may comprise one or more arrays of at least one individually addressable heating elements, wherein each heating element is individually and independently controllable, separate from other elements within the array of heating elements, wherein a voltage provided to each element, independent of a voltage provided to other elements is controllable, and wherein a temperature of each element is individually controllable independent of a temperature of other elements.

The array of individually addressable heating elements is arranged to transfer heat towards a region of a printing surface or a moving bed or a tray or a product positioned on said bed or table in proximity to, e.g., below said array. Heat transfer may be achieved by conduction, convection, radiation; by direct thermal contact with the object to be primed, e.g., solidified, cured or cooked, by focused radiation or by any other means permitting controlled solidification, curing or cooking of the product.

In some embodiments, thermal priming or cooking is by contact heating, e.g., utilizing a heating surface as disclosed herein.

As used herein, the term “priming” encompasses or is interchangeable with “solidifying”, “curing” and “cooking” or any means for transforming an assembled product of the invention into a final product, per user's demand. Depending on the product to be manufactured, its final state may be solid, or a form other than a solid, such as a gel, a paste, a powder or any non-liquid form. Where the product is a food product, it may be solidified or cooked to a degree preset by the user, as further defined herein. Where the product is not a food product, it may be formed into a solid, namely solidified, or formed into a final product by curing, as known in the art (in case it comprises a polymerizable material or a material that can be thermally treated or irradiated to undergo a chemical change). Thus, the term “priming” is not intended to limit the scope of products manufactured by a system and a method of the invention to any one physical form or to any one chemical or physical means for their assembly.

In some embodiments, a temperature sensor may be associated with each of the priming elements or with the array as a whole. The heating elements or the array of heating elements may be further connected to a controller for controlling each element independently. In some embodiments, the controller is configured and operable for sensing the existence of a load and its temperature. The controller may be alternatively configured for limiting the temperature, current and voltage of each of the elements by controlling voltage provided to the individual elements. The sequential activation of the individually addressable heating elements may also be controlled.

To measure an internal temperature of the product during production or final priming stage, e.g., solidification/curing/cooking step, the system may be provided with a temperature sensor that is configured to protrude into the product, e.g., a food product, to directly measure the internal temperature thereof.

In another aspect, the invention provides a system comprising a raw material unit, a product assembly unit and a product priming unit; wherein the raw material unit comprises a plurality of stationary raw material canisters (or reservoirs or containers), each being configured and operable to receive and/or hold a raw material and deliver a raw material; and wherein the product priming unit comprises an array of individually addressable heating elements arranged to transfer to or emit thermal radiation (heat) towards a region of a deposition surface, as disclosed herein.

Also provided is a system comprising a raw material unit, a product assembly unit and a product priming unit; wherein the raw material unit comprises a plurality of stationary raw material canisters (or reservoirs or containers), each being configured and operable to receive and/or hold a raw material; and wherein the product priming unit comprises a heating assembly comprising two heating surfaces, one of which being a bottom heating surface suitable for receiving a product to be primed or cooked and another heating surface being a top heating surface configured and operable to heat a top surface of the product, as disclosed herein.

In most general terms, the system of the invention comprises a main body having an inner space including a first space, a second space and optionally one or more further spaces, wherein the product manufacturing assembly is positioned in the first space and the product priming or cooking assembly is positioned in the second space. The spaces are typically not separated by a divider or a partition or are not distinct chambers within the inner space. The raw material processing unit may occupy one of the spaces.

In some embodiments, one space is operable at temperatures below room temperature (below 25-30° C.) and another space is operable at temperatures above room temperature (above 25-30° C.).

The printing or deposition surface on which the product is formed and subsequently optionally primed may be in the form of a moving bed or a tray, which may be heated, and which is configured and operable to receive thereon a manufactured object and further to move between the first space and second space of the system. The moving bed or tray may be positioned below the deposition tool, such that once product is deposited, the bed or tray moves in a direction of the priming or cooking zone, e.g., heating assembly, and delivers the product thereto.

The moving bed or tray is positioned to operatively move in all directions relative to the deposition tool and optionally also relative to the cooking zone or heating assembly. In some embodiments, however, the moving bed may be operable to move longitudinally, whereas the deposition tool may be configured and operable for moving in all directions. Where the deposition tool is an outlet of one or more of the canisters, the tool is stationary and fixed to the one or more canisters. In some embodiments, each and both the moving bed or tray and/or the deposition tool are independently configured and operable to move in all directions with respect to each other.

The need to provide a clean and a sanitized a reusable heating surface onto which the product may be deposited or delivered for priming or cooking presents a difficulty especially where the system of the invention is configured and operable for mass production of food products, or in cases wherein the time spanning between production of two consecutive products is to be maintained as short as possible. A suitable tool for cleaning and sanitizing the reusable tray or moving bed must be effective not only to clear out leftover liquids and solids remaining from a prior cooking cycle, but also provide a surface that is free of biological hazards that may develop overtime and may thus affect the safety of the food product. Also, in a customer operated system, discovering foreign materials in a food product, which may deviate from the product profile selected, or which would be unattractive to the consumer may result in a loss of confidence in the system, sales reductions, product recalls, and lawsuits.

Therefore, a system of the invention further contemplates a system for manufacturing a food product which comprises means for providing a clean, sanitized and thus biological hazard free substrate on which a food product may be formed and cooked. A cleaned and sanitized moving bed or tray or the surface on which the product is cooked is provided by way of a separator sheet that is provided a new for each cooking session. The separator sheet may be a reusable surface material that may be automatically wiped clean between any two cooking sessions or may be a disposable or sacrificial surface that is discarded after each cooking session. In most general terms, the disposable separator is automatically positioned on the region of the surface onto which the product is to be formed and/or cooked, such that direct contact between the surface and the product is avoided or limited. The separator may be in a form of a material sheet, wherein the material is inert to the product to be formed and the conditions of operation. The sheet may be of a material selected from a parchment paper, a wax paper, an aluminum foil, a non-absorbing paper, a cooking sheet, etc.

Thus, the system of the invention further comprises a dispenser unit for dispensing a separator sheet onto the moving bed or tray or the cooking surface.

In some embodiments, the dispenser unit is a roll-to-roll assembly comprising two or more rollers, wherein the separator sheet extends a distance between two of the rollers positioned to substantially confine the moving bed or tray or cooking surface, thereby having the sheet extend over the surface of the moving bed or tray; the rollers are configured to move the sheet a metered distance after every cooking session.

In some embodiments, the dispenser comprises a robotic assembly configured to clear the moving bed or cooking surface of a used separator sheet and position a new sheet on the vacant moving bed or tray or surface. In such embodiments, the robotic assembly may comprise a single moving arm or two or more arms, wherein at least one arm is configured and operable to clear out the moving bed or tray from the used sheet and at least one another arm is configured and operable to place a sheet on the bed or tray.

In some embodiments, the system comprises a tray or a compartment for holding sized sheets and optionally a tray or a receptacle for receiving the used sheets.

It will be appreciated by those of skill in the art that the system and method of its use according to the invention can be used to produce a variety of products such as food products as well as non-food products (such as polymeric products, ceramic products etc) according to preselected plans, using suitable raw materials or ingredients. The system may similarly be utilized in the production of a food product according to a recipe defined or selected by a user, via an additive manufacturing method, as disclosed herein.

In some embodiments of the invention disclosed herein, the system is for manufacturing a food product. In such embodiments, the raw materials may be any one or more of proteins from various sources, fats from a variety of sources, sugars, flavoring agents, coloring agents, salts, oils and other liquids, and others, each of which being contained in a separate canister and may be delivered to a mixing container or the printing head, as disclosed herein.

Thus, the invention further provides a system for manufacturing a food product, the system being a system unit according to the invention.

In some embodiments, the system comprises a plurality of deposition areas (or beds or trays), the plurality of deposition areas being in a form of (a) a food bed having a surface defining at least two deposition areas, or (b) two or more deposition beds; a printhead assembly; and a heating assembly.

A system of the invention further comprises computer software and a user interface that may or may not be physically mounted on the system. Notwithstanding, the user interface allows a user to quickly and efficiently define or characterize or select any one or more features of the product to be printed. Where the product is a food product, the user may select the weight and size of the product, the ingredients the food product will contain or will be free of, the level of cooking, etc.

The user interface may be in a form of a computer or any device capable of accessing a network. The device may be a notebook, a desktop, a laptop, a tablet, a wireless communication device, a personal digital cellular terminal, a personal handphone system terminal, a smartphone, a wearable device and the like.

The computer software may be stored in a computer-readable memory that can direct a computer or other programmable data processing unit to function in a particular manner, such that the instructions stored in the computer-readable memory produce the product. The computer program instructions may be loaded onto a computer or other programmable data processing unit to cause a series of operational steps to be performed on the computer or other programmable apparatus to produce a computer implemented process such that the instructions which execute on the computer or other programmable unit provide steps for producing the product.

The programmable data processing unit may include typical components such as a bus for communicating information, and a processor coupled with the bus for processing information, random access memory coupled to the bus for storing information and instructions to be executed by the processor. Access memory may be used for storing temporary variables or other intermediate information during execution of instructions by the processor, a read only memory coupled to the bus for storing static information and instructions for the processor, and a data storage device coupled to the bus for storing information and instructions. The system may further be coupled via the bus to a display device, such as an LCD monitor or panel, for displaying information to a user. The programmable data processing unit further comprises a keyboard and a cursor control, or a keypad.

The system may further include a microcontroller circuit, a display electrically coupled to the microcontroller circuit, and a thermal printer, also electrically coupled to the microcontroller circuit. The thermal printer is configured to print a food product label to be attached to the food product.

The product manufacturing assembly may further comprise a controller that coordinates and executes the necessary instructions to create the product design and composition chosen by the user. It may control motors, sensors and transducers and get information back from each. A control panel may also be included as part of the product manufacturing assembly or as an external device that acts as a user interface device and communicates with the controller to produce an effective and simple user experience to the end user. It may also interact with the Internet and mobile devices such as smartphones or tablets.

A system of the invention is easily and efficiently operable by a user from a user interface which may be provided part of the system or a user interface that is remotely operated or cloud operated.

In selecting the parameters or features of the product to be produced by the product manufacturing assembly, the user will select the type of product, e.g., type of food product to be prepared. The product may be dairy product, an allergen free product, a vegan product, a vegetarian product, a low-salt product, a product suitable for diabetics, a kosher product, etc. Next, the user may select the size of the product to be produced, its shape and the ingredients making up the product, as defined herein. The user may further select the level of product cooking.

Once the selection process is completed, the selection is sent to the system through a relay means directing each of the systems units to produce a set of actions leading eventually to the production of the product.

### Exemplary Machine Operation:

When set to ON, the system starts a prep process, which includes turning on the heaters, confirming presence of raw materials canisters and their validity through the use of canister specific RFID tags. The machine indicates its readiness.

Once proper operation is confirmed, the system may start receiving orders and file numbers and starts producing the food products.

In some embodiments, a system comprises multiple (in some examples 3, 4 or 5) raw material canisters. Each holds a raw material in a powder to liquid form. According to a chosen set of user instructions, or a preset file, the system meters a first raw material, e.g., a protein powder mix (canister #1) and a cellulosic material (canister #2) into a first mixing container. A fluid is metered by a peristaltic pump and the powder is metered by a powder metering system. In parallel, another powder such as Methocel (canister #3), a cellulosic material (canister #2) and oil (canister #4) are metered into a second mixing container.

The powder and the cellulosic material in the first mixing container are then mixed by a first mixer unit. In parallel, the raw materials in the second mixing container are mixed by a second mixer. The first mixing container is then moved to an extrusion position and a 2-stage piston presses the protein mixture through a >120° C. cavity, with a 5 mm thin nozzle at its bottom. The resulting extrusion product is delivered into the second mixing container. An additional oil (canister #4) and water (canister #5) are added to the mixture. The second mixer mixes the fine mixture and retracts back. A piston then pushes the wet mixture through the printhead nozzle, e.g., while being moved along the Z and Y directions relative to a printing table that moves on the X direction; thereby forming the product.

At the end of the printing process, the product is pushed or moved to the curing or cooking zone onto a bottom heater, by a linear pushing rod. A top heater is then moved down to clamp the product and broil or cook it on both sides. Once cooking is achieved per selection of the user, the top heater is moved. Another pushing rod pushes the patty off the bottom heater and into the extraction drawer from which the product may be withdrawn.

The invention further provides a method for manufacturing a 3D object, the method comprising receiving one or more customer-specified requirement relating to a food product profile (composition, size, shape, etc) and executing a set of machine instructions specifying a manufacturing process suitable for manufacturing the food product based on the food product profile.

In some embodiments, the method is carried out utilizing a system according to the invention.

In accordance with the invention, the method utilizes a system comprising a raw material assembly unit, a product assembly unit and a product priming unit.

In some embodiments, the system comprises at least two printing or deposition areas on a surface or two or more printing or deposition beds previously deposited with a food component and thermally treated, the process comprises:
depositing (e.g., by way of extraction) an amount of a food component on one or more deposition areas or beds and thermally treating said deposited food component on said areas or beds; simultaneously therewith treating the one or more areas or beds previously deposited with a food component and thermally treated under conditions of selective thermal conditioning,
thermally treating the areas or beds deposited and thermally treated; and simultaneously therewith depositing and thermally treating the thermally treated one or more previously deposited and thermally treated printing areas or printing beds, and
repeating the steps to construct the food products.

The invention further provides a system for forming a food product, the system being configured to operate in consecutive cooking cycles, each cooking cycle is configured and operable to produce a food product based on a predefined food profile; the system comprising a substrate (moving bed, or tray, etc) configured to receive the food product and a dispenser unit for dispensing a separator sheet onto the moving bed or tray between each consecutive cooking cycles.

In some embodiments, the dispenser unit is a roll-to-roll assembly comprising two or more rollers, wherein the separator sheet extends a distance between two of the rollers positioned to substantially confine the moving bed or tray, thereby having the sheet extend over the surface of the moving bed or tray; the rollers are configured to move the sheet a metered distance after every cooking session.

In some embodiments, the dispenser comprises a robotic assembly configured to clear the moving bed of a used separator sheet and position a new sheet on the vacant moving bed or tray. In such embodiments, the robotic assembly may comprise a single moving arm or two or more arms, wherein at least one arm is configured and operable to clear out the moving bed or tray from the used sheet and at least one another arm is configured and operable to place a sheet on the bed or tray.

In some embodiments, the system comprises a tray or a compartment for holding sized sheets and optionally a tray or a receptacle for receiving the used sheets.

In other aspects and embodiments of the invention, there is provided a system unit according to any of the aforementioned aspects, as follows:

A digital manufacturing system unit for manufacturing a food product, the system unit being a non-partitioned system unit comprising a raw material metering and mixing unit, a food product assembly unit and a food product cooking unit, the system unit being configured and operable to receive one or more customer-specified requirement relating to a food product profile and execute a set of machine instructions specifying a manufacturing process suitable for manufacturing the food product based on the food product profile, thereby manufacturing the food product.

The system unit according to the invention comprises a raw material processing unit.

The system unit according to the invention, wherein the raw material metering and mixing unit comprises a plurality of stationary raw material canisters, each being in material communication with one or more mixing containers or with a printing head or deposition tool.

The system unit according to the invention, wherein each of the plurality of stationary raw material canisters is provided with a material outlet configured as a deposition tool.

The system unit according to the invention, wherein the raw material metering and mixing unit comprises a plurality of stationary raw material canisters, each optionally refrigerated or maintained at a temperature below room temperature (below 25-30° C.).

The system unit according to the invention, wherein each of the plurality of stationary raw material canisters is configured to receive a raw material from an external reservoir or an external source or is a pre-filled disposable canister.

The system unit according to the invention, wherein each of the plurality of stationary raw material canisters is oriented at an angle to a deposition surface.

The system unit according to the invention, wherein each of the plurality of stationary raw material canisters is similarly oriented.

The system unit according to the invention, wherein each of the plurality of stationary raw material canisters is perpendicularly or horizontally oriented with respect of a deposition surface.

The system unit according to the invention, wherein each of the plurality of stationary raw material canisters is equipped or associated with a decanting mechanism operable to permit uninterrupted flow of raw materials therefrom.

The system unit according to the invention, wherein each of the plurality of stationary raw material canisters is provided with an output opening or valve from which material is dispensed.

The system unit according to the invention, wherein the food product assembly unit comprises a deposition tool configured to discharge any one or more raw materials or a combination of raw materials via one or more nozzles.

The system unit according to the invention, wherein the nozzles are provided with an end receiving the raw materials or combination thereof and an outlet end through which the raw material or combinations thereof is discharged.

The system unit according to the invention, wherein the outlet end is provided with a planar extension that extends an outer circumference of the nozzle.

The system unit according to the invention, wherein the planar extension is a heated body which permits thermal cooking of the product.

The system unit according to the invention, wherein the deposition tool is configured for linear motion or a rotational motion onto a deposition surface, being optionally heated.

The system unit according to the invention, wherein both the deposition tool and the deposition surface have freedom to move in all directions relative to each other.

The system unit according to the invention, wherein the product cooking unit is configured for receiving the food product and treating same to endow it with final desired characteristics.

The system unit according to the invention, wherein the cooking unit comprises an element selected from a heating lamp, a heating body, a UV lamp, an IR lamp, a laser, a hot air nozzle, or a heating surface.

The system unit according to the invention, wherein the cooking unit comprises a substrate with a multiplicity of heating elements arranged in an array form.

The system unit according to the invention, wherein the array comprises multiple individually addressable heating elements, each of the elements may be same or different.

The system unit according to the invention, wherein each of the elements is addressed at the same time or at different time points.

The system unit according to the invention, wherein the cooking unit comprises a heating assembly comprising two heating surfaces, one being a top heating surface and the other a bottom heating surface configured to receive the food product therebetween.

The system unit according to the invention, wherein position of either the top surface or the bottom surface is modified such that the product is in contact with the bottom heating surface or with both surfaces.

The system unit according to the invention, comprising a deposition surface in a form of a moving bed or a tray.

The system unit according to the invention, wherein the deposition surface is configured and operable to move below the deposition tool.

The system unit according to the invention, wherein the deposition surface is operable to move longitudinally, whereas the deposition tool is configured and operable for moving in all directions.

The system unit according to the invention, wherein each and both the deposition surface and/or the deposition tool are independently configured and operable to move in all directions with respect to each other.

The system unit according to the invention, wherein the deposition surface is configured and operable to move in all directions, whereas the deposition tool is stationary.

The system unit according to the invention, comprising a dispenser of separator sheet configured to dispense a separator sheet onto the deposition surface or a heating surface.

The system unit according to the invention, wherein the dispenser is a roll-to-roll unit, a dispenser of separate sheets or a roll-to-cut dispenser.

The system unit according to the invention, wherein the dispenser is a roll-to-roll dispenser comprising two or more rollers, wherein a separator sheet extends a distance between two of the rollers positioned to substantially confine the deposition or heating surface, the rollers are configured to move the sheet a metered distance after every cooking session.

The system unit according to the invention, wherein the system unit comprises a heating assembly comprising two heating surfaces, one being a top heating surface and the other a bottom heating surface configured to receive the food product, each of the two heating surfaces is adapted with the dispenser.

The system unit according to the invention, the system unit comprising a robotic assembly configured to clear the deposition surface or the heating surface of used separator sheets and position new sheet on a vacant surface.

The system unit according to the invention, for manufacturing a food product, wherein the raw materials are selected from proteins, fats, sugars, flavoring agents, coloring agents, salts, oils and other liquids, each of which being contained in a separate canister, or premixed and contained in mixed-material canisters.

The system unit according to the invention, for manufacturing a product selected from a dairy product, an allergen free product, a vegan product, a vegetarian product, a low-salt product, a product suitable for diabetics, and a kosher product.

The system unit according to the invention, comprising computer software and a user interface.

The system unit according to the invention, wherein the user interface is in a form of a computer or a device capable of accessing a network.

The system unit according to the invention, wherein the device is a notebook, a desktop, a laptop, a tablet, a wireless communication device, a personal digital cellular terminal, a personal handphone system terminal, a smartphone, or a wearable device.

Also provided is a method for digital manufacturing a food product, the method comprising in a system unit being a non-partitioned system unit comprising a raw material metering and mixing unit, a food product assembly unit and a food product cooking unit,
receive one or more customer-specified requirement relating to a food product profile;
execute a set of machine instructions specifying a manufacturing process suitable for manufacturing the food product based on the food product profile, wherein said manufacturing process comprising;
delivering a metered amount of one or more raw materials from the raw material metering and mixing unit;
assembling the food product into a final food product; and
cooking said product;
wherein the cooked final product is in accordance with the one or more customer-specified requirement relating to a food product profile.

The method according to the invention, wherein the system unit is a system unit according to the invention.

The method according to the invention, wherein the food product profile comprises product composition, product size and/or product shape.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a schematic view of a system for producing substances in accordance with embodiments of the present invention.

FIG. 2 is a schematic view of a flow chart of a process producing substances with an apparatus for producing substances in accordance with embodiments of the present invention.

FIG. 3 is a schematic depiction of a system unit according to the most general aspects of the invention.

FIG. 4 is a schematic depiction of a system unit according to some embodiments of the invention.

FIGS. 5A-B provide a more detailed view of a system unit according to the invention.

FIGS. 6A-B provide a detailed view of a canister assembly and a deposition surface according to the invention.

### DETAILED DESCRIPTION OF EMBODIMENTS

Illustrative embodiments of the invention are described below. In the interest of clarity, not all features/components of an actual implementation are necessarily described.

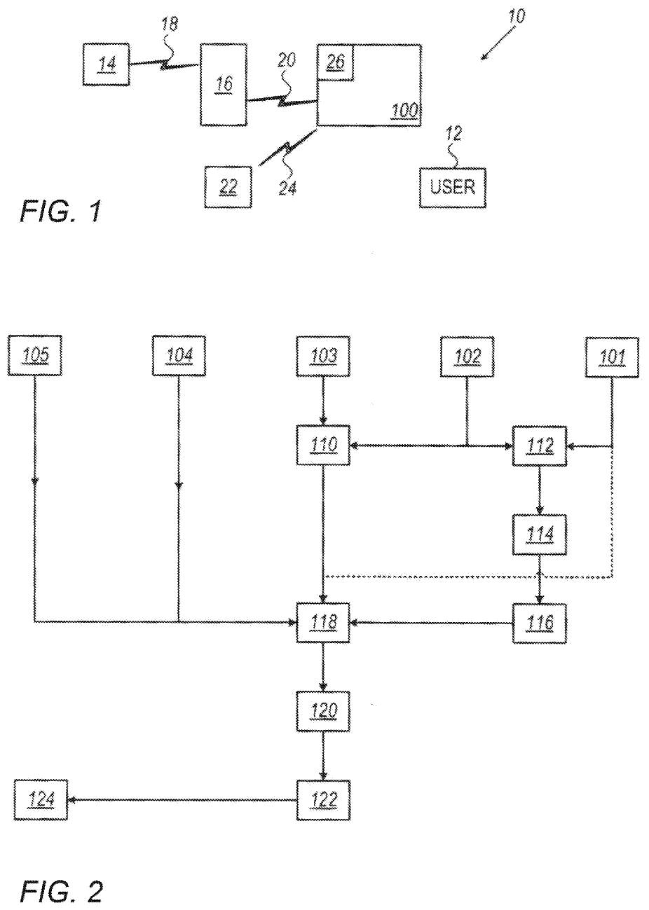

FIG. 1 is a schematic view of a system 10 for producing substances in accordance with embodiments of the present invention. System 10 comprises a system unit 100, a first communication device 14, a second communication device 22, and a computer server device 16. System unit 100 is configured to produce substances on demand in accordance with predefined parameters. A user demand typically provides a description of a required substance, and predefined parameters relating to particular characteristics of the required substance. A description of a required substance may provide a name of a substance (food-hamburger, food-vegan desert), and/or a general description of the required substance (medicine-mild pain killer).

The first communication device 14 and the second communication device 22 may be alternatives or may coexist.

A demand comprising predefined parameters may be inserted by user 12. The term “user” may be alternatively referred throughout this application also as “consumer”. First communication device 14 and second communication device 22 may be any communication device able to communicate data in any form, e.g., analog or digital form, such as a computer, phone or other data communicating device. First and second devices 14; 22, respectively, comprise a transmitter and optionally also a receiver, for transmitting and receiving data. System unit 100 comprises a communication element 26. Communication element 26 comprises communication receiver, and optionally a communication transmitter, for receiving and/or transmitting data from a consumer using any of any of first and second communication devices 14; 22. Communication between any of first communication device 14 or second communication device 22 to system unit 100 may be a transmission of a demand for a substance, and optionally, predefined parameters of the substance; a transmission of acknowledging receipt of demand with predefined parameters (optionally, further data such as cost of the substance, time for receiving the substance, as well as other information) from system unit 100 to any of first communication device 14 and second communication device 22. Communication systems 18, 20, and 24 may be of any form of transmission, e.g., wireless or data line. First communication device 14 may communicate data to and from system unit 100 using computer server device 16, via communication systems 18, 20. Similarly, second communication device 22 may communicate data to and from, system unit 100 directly via communication system 24 without use of a computer server device 16 (e.g., hot spot communication).

A communication to system unit 100 comprising a demand for a substance to be produced, and, optionally, predefined parameters of the substance, is referred in this application alternatively as a “predefined order”. A predefined order may be transmitted to system unit 100 by user 12 using any of first communication device 14, and/or second communication device 22. Alternatively, user 12 may directly communicate predefined order to system unit 100. Direct communication to system unit 100 may be by pressing designated order buttons placed on system unit 100; voice recognition device installed in system unit 100, and the like. System unit 100 is configured to communicate with a user by transmitting an acknowledgement, and/or present a question to any of communication devices 14, 22, using any of communication systems 18, 20, and 24 and computer server device 16. Alternatively, system unit 100 may communicate directly with use 12 by a screen presenting an acknowledgement, and/or present a question, and/or generating a voice message, and/or sending communication to a user's communication device (e.g., a phone, a computer device).

FIG. 2 is a schematic general view of a flow chart of materials in a process of producing substances or compositions or mixtures in accordance with some embodiments of the present invention.

In a unit system unit 100, as depicted in FIG. 1, an array of canisters/cartridges 101, 102, 103, 104, 105 comprises raw materials which may form ingredients of substances in accordance of a predefined order. Raw materials stored in canisters 101, 102, 103, 104, 105 may be in any state, such as solid state (e.g., powder form), liquid state (different liquids with different viscosities), and gas state (e.g., CO₂). Once a system unit 100 receives a predefined order a process for producing the ordered substance is initiated. In the FIG. 2 the arrows (i.e., the lines connecting between the numbered items in FIG. 2) represent means of transferring and/or additional ingredients treatment between different actions of execution of a predefined order by system unit 100. Accordingly, the arrows in FIG. 2 may comprise one or more of conduits, extruders, pumps, pistons, blowers, vibrating means, as well as other means for transferring materials between different positions. Additionally, or alternatively, the arrows in FIG. 2 may indicate presence of heating means, cooling means, and other external effect on the processing of substance in system unit 100. Some of the actions shown in FIG. 2 are executed chronologically in parallel, or partially in parallel, to other actions, and part of the actions chronologically follow only after completion of an earlier action, i.e., an earlier stage. The process of producing substances with system unit 100 may be monitored, intermediate actions, and stages, as well as the end product of the predefined order. Monitoring is performed regarding predefined parameters of ingredients, actions, or combination thereof, at different positions during the process of substances in system unit 100. Exemplary monitored parameters measured during the process and of the final produced substance relate to time (e.g., expected time frame), temperature limit (e.g., low limit, high limit), quantity (e.g., expected weight and/or volume), and viscosity value (e.g. predefined viscosity value range).

Following a predefined order received in system unit 100 consecutive actions are performed in order to provide the substance included in the predefined order. Accordingly, a predefined metered quantity of raw materials stored in containers 101 and 102 are transferred to mixing location 112 which may be a designated mixing container. Mixing container 112 may comprise a mixer and/or heating/cooling device enabling sufficient mixing of raw material received from containers 101 and 102. In parallel/partially parallel transferring of raw materials from containers 101, 102 to mixing container 112, raw materials from containers 102, 103, are transferred to mixing container 110, and raw materials from containers 104, 105, are transferred to mixing container 118. Each of mixing containers 110, 118 may comprise a designated mixing container, a mixer, a heating/cooling device enabling sufficient mixing and control over the temperature of the mixtures. According to the embodiments referred to in FIG. 2 the mixture of raw materials from containers 102, 103 at mixing container 110 is an intermediate stage before introduced as part of a new mixture at mixing container 118. Mixture of raw materials from containers 101, 102 at mixing container 112 has further treatment, e.g., extrusion at extrusion location 114, cooling at cooling location 116, before introduced as part of a new mixture at mixing location 118. Adding the different components of the mixture introduced at mixing location 118 is performed according to predefined data. Following mixing of ingredients at mixing location 118 the mixture is introduced to 3D printing head/deposition tool 120 (3DPH 120). 3DPH 120 may comprise a further treatment stage, e.g., further mixing, processing, adding of materials, or combination thereof, and distributes the basic outlined shape of the processed substance before the priming or cooking stage 122. The 3DPH may be provided with a heating element for achieving focused, direct or contact heating. The priming stage involves a heating stage in a form of a heating tray or surface and/or further heating elements that would convert the product into its final form, whether fully solid, partially solid, powdery, gelloues, semi-gellous, liquidy or otherwise amorphic in form. The product manufacturing process is finalized after priming stage 122 by extraction 124 from the system unit 100 to provide the consumer with the product per the predefined order.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

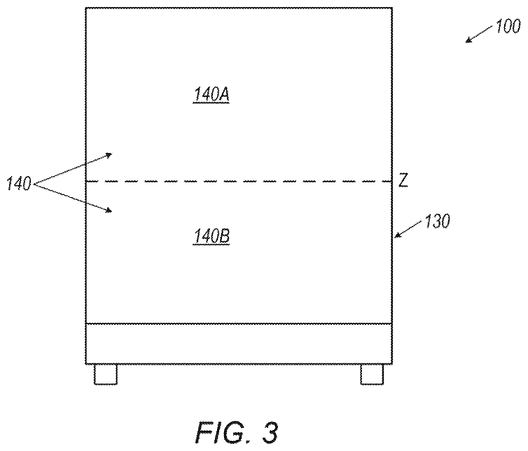

FIG. 3 presents a schematic depiction of a system unit 100 according to the broadest embodiments of the invention. As disclosed herein, system 100 comprises a main body 130 having an inner space 140 including a first space 140A, a second space 140B and optionally one or more further spaces (not shown). The spaces may be designed to occupy any region of the inner space 140. The product manufacturing assembly may be positioned in the first space 140A and the product priming or cooking assembly may be positioned in the second space 140B. The spaces are typically not separated by a divider or a partition Z (shown for clarity only) or are not distinct chambers within the inner space 140. The raw material processing unit may occupy any one of the spaces.

In some embodiments, the first space 140A is operable at temperatures below room temperature (below 25-30° C.) and the second space 140B is operable at temperatures above room temperature (above 25-30° C.).

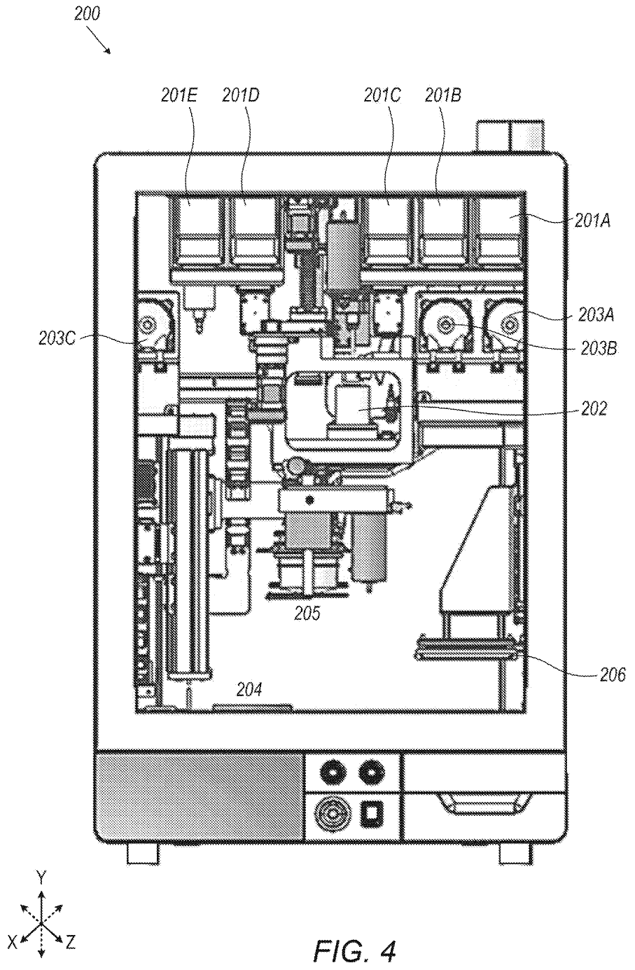

FIG. 4 presents a more detailed schematic depiction of a system unit 200 according to the invention.

As shown, a plurality of canisters or cartridges 201A, 201B, 201C, 201D, and 201E are positionally fixed to the frame of the unit and are configured to discharge metered amounts of materials contained therein into an optionally available mixing assembly comprising a mixing unit 202 and metering units 203A, 203B and 203C. Mixed proportions of the raw materials may be then transferred to the deposition tool or printing head 205 and deposited on surface 204 capable of movement at any direction (X, Y, Z) with respect of the deposition tool 205 and the heating surface 206. Once deposited, the surface 204, being itself a heating surface, moves into proximity to the heating surface 206. In the configuration shown in FIG. 4, both the deposition surface 204, regarded a bottom heating surface, and the heating surface 206, regarded a top heating surface, may be moved towards each other sandwich the product therebetween to achieve contact heating or contact cooking.

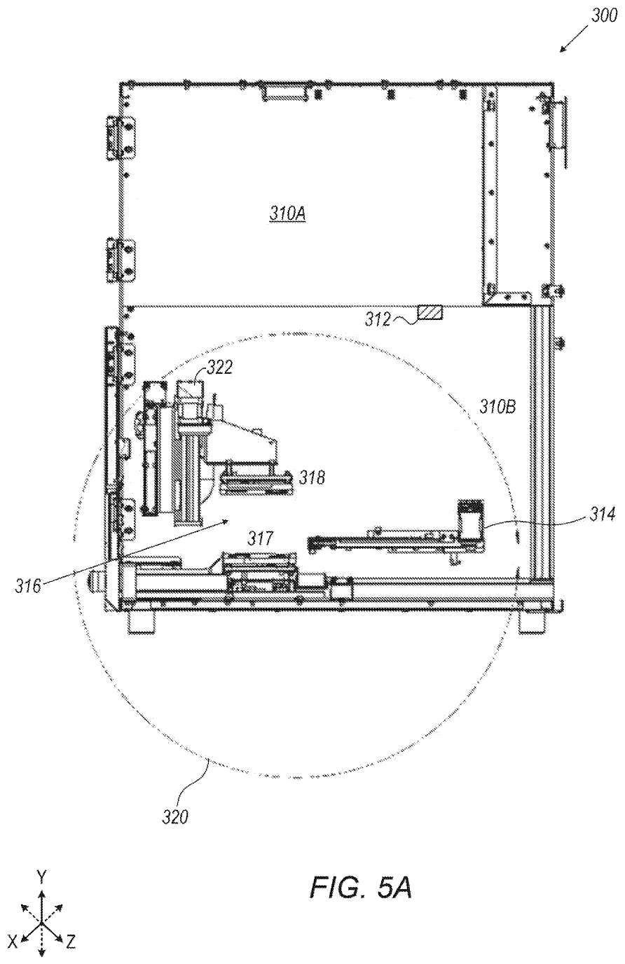

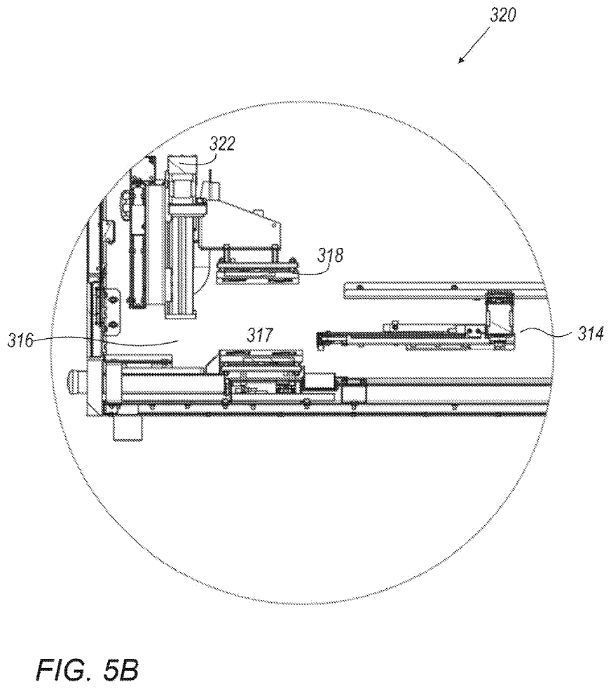

FIGS. 5A-B provide another depiction of a unit according to some embodiments of the invention. FIG. 5A shows a side view of a unit 300, having a raw material zone 310A, which may be maintained at temperatures below room temperature, as detailed herein, and a product preparation zone 310B that is maintained at a temperature above room temperature. The two zones are not separated by a partition or a thermally insulating barrier. The raw material zone 310A comprises the plurality of material canisters or cartridges (not shown), each having an outlet (exemplified by an outlet 312, acting also as the deposition tool or printhead) for delivering a metered amount of a material contained therein onto the deposition surface 314. The deposition surface is configured and operable to move in all X, Y, Z directions with respect to outlet 312 and the heating assembly 316. Heating assembly 316 includes a bottom heating surface 317 and a top heating surface 318 that can be moved to a desired distance from the bottom surface 317 via a lift assembly 322.

An enlarged view of region 320 is shown in FIG. 5B

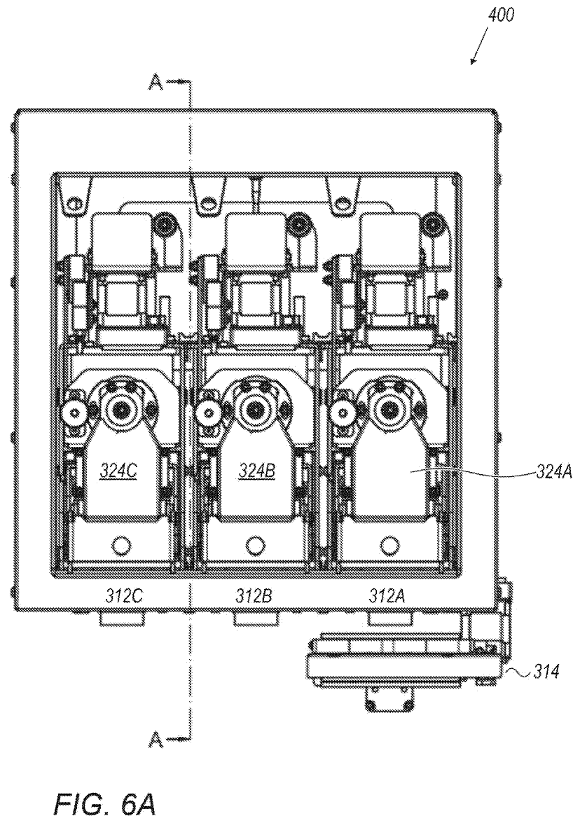

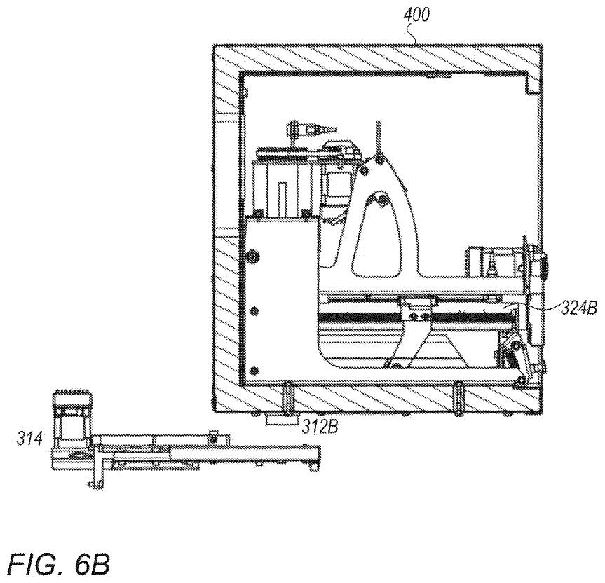

FIGS. 6A-B show a refrigerated raw material zone 400. A front view is shown of three canisters 324A, 324B and 324C positioned horizontally with respect to the deposition surface 314, each having a respective outlet 312A, 312B and 312C, respectively. Each canister outlet is an individually operable print head or deposition tool capable of delivering a metered amount of a material contained therein onto the deposition surface 314. The three depicted canisters are maintained within zone 400 that is refrigerated, shown in FIG. 6A. Deposition surface 314 is positioned immediately below an outlet 312A and may be movable between the canister outlets and away from the canisters in the direction of the heating assembly, as shown in FIG. 5A. A side view of zone 400 shown via line A in FIG. 6A is shown in FIG. 6B.

1-42. (canceled)

43. A digital manufacturing system unit for manufacturing a food product, the system unit being a non-partitioned system unit comprising a raw material metering and mixing unit, a food product assembly unit and a food product cooking unit, the system unit being configured and operable to receive one or more customer-specified requirement relating to a food product profile and execute a set of machine instructions specifying a manufacturing process suitable for manufacturing the food product based on the food product profile, thereby manufacturing the food product,
wherein the raw material metering and mixing unit comprises a plurality of stationary raw material canisters, each being in material communication with one or more mixing containers or with a printing head or deposition tool.

44. The system unit according to claim 43, wherein the raw material metering and mixing unit is refrigerated or maintained at a temperature below room temperature (below 25-30° C.).

45. The system unit according to claim 43, wherein each of the plurality of stationary raw material canisters is configured to receive a raw material from an external reservoir or an external source or is a pre-filled disposable canister.

46. The system unit according to claim 43, wherein each of the plurality of stationary raw material canisters is equipped or associated with a decanting mechanism operable to permit uninterrupted flow of raw materials therefrom.

47. The system unit according to claim 43, wherein the food product assembly unit comprises a deposition tool configured for linear motion or a rotational motion onto a deposition surface, being optionally heated.

48. The system unit according to claim 47, wherein both the deposition tool and the deposition surface have freedom to move in all directions relative to each other.

49. The system unit according to claim 43, wherein the product cooking unit is configured for receiving the food product and treating same to endow it with final desired characteristics. wherein the cooking unit comprises an element selected from a heating lamp, a heating body, or a heating surface.

50. The system unit according to claim 43, wherein the cooking unit comprises a surface with a multiplicity of heating elements arranged in an array form.

51. The system unit according to claim 50, wherein the array comprises multiple individually addressable heating elements, each of the elements may be same or different.

52. The system unit according to claim 43, wherein the cooking unit comprises a heating assembly comprising two heating surfaces, one being a top heating surface and the other a bottom heating surface configured to receive the food product therebetween. wherein position of either the top surface or the bottom surface is modified such that the product is in contact with the bottom heating surface or with both surfaces.

53. The system unit according to claim 43, comprising a deposition surface in a form of a moving bed or a tray.

54. The system unit according to claim 53, wherein the deposition surface is configured and operable to move below the deposition tool.

55. The system unit according to claim 54, the system unit comprising a robotic assembly configured to clear the deposition surface or the heating surface.

56. The system unit according to claim 43, for manufacturing a food product, wherein the raw materials are selected from proteins, fats, sugars, flavoring agents, coloring agents, salts, oils and other liquids, each of which being contained in a separate canister, or premixed and contained in mixed-material canisters.

57. The system unit according to claim 56, for manufacturing a product selected from a dairy product, an allergen free product, a vegan product, a vegetarian product, a low-salt product, a product suitable for diabetics, and a kosher product.

58. The system unit according to claim 43, comprising computer software and a user interface.

59. The system unit according to claim 58, wherein the user interface is in a form of a computer or a device capable of accessing a network.

60. The system unit according to claim 59, wherein the device is a notebook, a desktop, a laptop, a tablet, a wireless communication device, a personal digital cellular terminal, a personal handphone system terminal, a smartphone, or a wearable device.

61. A method for digital manufacturing a food product, the method comprising in a system unit being a non-partitioned system unit comprising a raw material metering and mixing unit, a food product assembly unit and a food product cooking unit,
receive one or more customer-specified requirement relating to a food product profile;
execute a set of machine instructions specifying a manufacturing process suitable for manufacturing the food product based on the food product profile, wherein said manufacturing process comprising;
delivering a metered amount of one or more raw materials from the raw material metering and mixing unit;
assembling the food product into a final food product; and
cooking said product;
wherein the cooked final product is in accordance with the one or more customer-specified requirement relating to a food product profile.

62. The method according to claim 61, wherein the food product profile comprises product composition, product size, degree of cooking and/or product shape.
